(19) United States
(12) Patent Application Publication
(10) Pub. No.: US 2005/0109444 A1
(43) Pub. Date: May 26, 2005

(54) Sealing assembly

(75) Inventor: David B. Kochan, Mississauga (CA)

Correspondence Address: SMART AND BIGGAR, 438 UNIVERSITY AVENUE, SUITE 1500 BOX 111, TORONTO, ON, M5G2K8, CA

(73) Assignee: Skymark Packaging Systems Inc.

(21) Appl. No.: 10/720,224

(22) Filed: Nov. 25, 2003

(51) Int. Cl. B32B 31/00; B65B 9/00; B65B 51/10

(52) U.S. Cl. 156/64; 53/370.7; 53/450; 156/380.1; 156/358

(57) ABSTRACT

For a vertical form, fill, and seal machine, the motion profile of the sealing jaws is controlled to reduce turbulence of fluid in the tube thereby promoting a better seal. Additionally, the jaws have an endless stroke so that a consistent sealing pressure may be achieved even after the jaws have worn down with repeated use.

### CROSS-REFERENCE TO RELATED APPLICATION

This application is related to U.S. patent application Ser. No. 10/625,875, filed on Jul. 23, 2003, naming Stefan Tobolka as its inventor. The related application is hereby incorporated by reference.

### BACKGROUND OF INVENTION

1. Field of the Invention

This invention relates to an assembly for sealing containers; in particular, it relates to a novel sealing assembly for sealing a web of thermoplastic film or other materials into a series of containers.

2. Description of the Related Art

Sealing machines are used to package fluids, such as granular materials or liquids of various viscosities, from water to syrup in pouches. One type of package or pouch-making machine is a vertical form, fill and seal machine. With vertical form, fill, and seal machines, a heat sealable web material may be supplied from a roll. The flat web material may be unwound and formed into a vertically oriented tube which surrounds a fluid delivery device, such as a spigot. A sealing assembly may be located below the delivery device, sealing across the tube by heat pressing the two layers of web materials together through the use of a moving sealing head reciprocating toward and away from the tube opposite a backstop. Initially, a bottom seal may be made and a quantity of flowable material delivered to the tube. The tube may then be indexed downwardly, and another seal made above the bottom seal so as to form a pouch between the two seals. The second seal will also act as a first seal for the next-to-be formed pouch.

FIG. 1 illustrates an exemplary vertical form, fill, and seal machine 100, in which a flat web 112 of film is unwound from a roll 110 and sealed into a tube 114 surrounding a spigot 116 by a sealing head 118. The spigot is used to deliver a fluid to the tube and a sealing assembly 122 may then be used to seal and cut filled pouches 120 from the tube 114. The filled pouches may be discharged from the machine onto a conveyor belt 130. The film of the web may be made of a heat sealable flexible, light-weight material, such as a polyethylene/polypropylene laminate or other similar plastic materials.

The speed of machine 100 may be increased if, rather than metering out a suitable volume of fluid for each pouch before the upper seal to complete the pouch is formed, the tube 114 is filled above the level where the upper seal will be formed. Sealing devices that form a seal through a liquid-containing tube are known in the art. For example, U.S. Pat. No. 5,038,550 by Wirsig and Perret, discloses a vertical form, fill and seal machine with a pair of transverse heat sealing jaws, a pair of spreader fingers, and at least a pair of detucker fingers to pinch a longitudinal edge of the tubular film. Another example is the vertical form, fill, and seal device described in U.S. Pat. No. 6,164,042 by Tobolka. A drawback with sealing below the fluid level, however, is that if the sealing jaw is reciprocated quickly, it will impart turbulence to the fluid and consequent vibrations to the tube, which can result in an inferior seal being formed. This risks forming pouches that leak.

Another drawback with known sealing devices is that as the sealing jaws wear down with repeated cycling, the sealing pressure between them reduces. This risks leaking pouches, which when this occurs necessitates re-calibration of the device or replacement of the sealing jaws.

Therefore, there remains a need for a rapid sealing assembly that will minimize hydraulic turbulence and tube vibration, the occurrence of which may weaken the bond between the layers of the material forming the container, and that will also manage a consistent sealing pressure over many cycles.

### SUMMARY OF THE INVENTION

To seal a tube, such as a tube in a vertical form, fill, and seal machine, the motion profile of sealing jaws is controlled to reduce turbulence of fluid in the tube and vibration of the tube, thereby promoting a better seal. Additionally, the jaws have an endless stroke so that a consistent sealing pressure may be achieved even after the jaws have worn down with repeated use.

According to one aspect of this invention, a device for sealing a tube containing a fluid is provided. This device comprises a pair of opposed jaws disposed about the tube, and a motor for driving each one of the opposed jaws toward the other. An indicator, such as a motor rotation indicator, is provided for indicating position of said jaws. A controller is input by the indicator and outputs to the motor for controlling a motion profile of the jaws.

According to another aspect of this invention, a method for sealing a flexible tube containing a fluid is provided. This method involves driving opposed jaws disposed about a tube toward each other and controlling the speed and rate of speed of said jaws in order to reduce turbulence in the fluid and vibration of the tube as the jaws deform the tube. The jaws are driven into abutment with the tube interposed between the jaws a sealing pressure is applied for a dwell time, and then the jaws are retracted.

Other features and advantages of the invention will become apparent from a review of the following description in conjunction with the figures.

### BRIEF DESCRIPTION OF THE DRAWINGS

In the figures which disclose example embodiments of the invention:

FIG. 1 is a perspective view of a conventional vertical form, fill and seal machine discharging onto a conveyor belt a succession of sealed pouches.

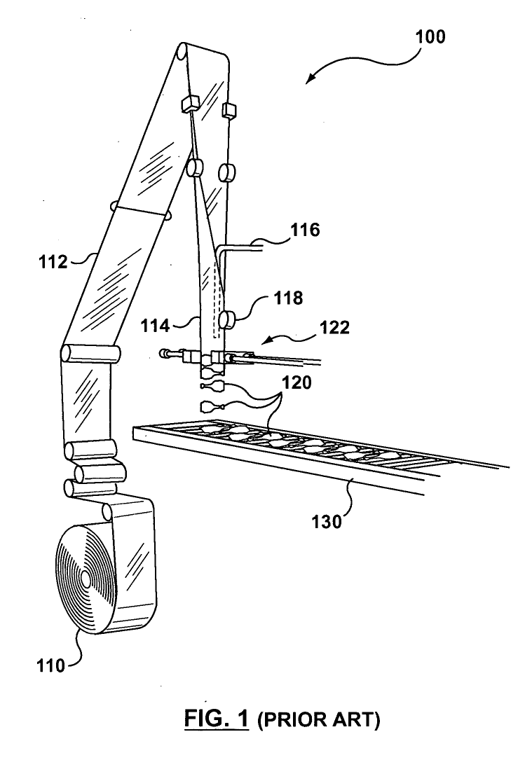

FIG. 2 is the top view of a sealing assembly made in accordance with an embodiment of the invention.

FIG. 3 is the front view of the sealing assembly of FIG. 2.

FIG. 4 is velocity v. time diagram illustrating the velocity profile of a sealing head of the sealing assembly of FIG. 3.

FIG. 5 is the top view of an alternative embodiment of a sealing assembly made in accordance with this invention, using a rack and pinion assembly instead of levers to move the sealing heads.

FIG. 6 is an enlarged breakaway view of the rack and pinion assembly of FIG. 5.

### DETAILED DESCRIPTION

A sealing assembly is employed to clamp together layers of suitable materials, such as two layers of flexible laminate plastic film and to bond the layers by applying heat and a controlled amount of pressure. In one embodiment of the invention, the sealing assembly includes an upper and lower pair of jaws, each slidably mounted on a pair of parallel shafts, with a mechanism for effecting reciprocal movement of the jaws, together and apart, as required to clamp together the container forming material.

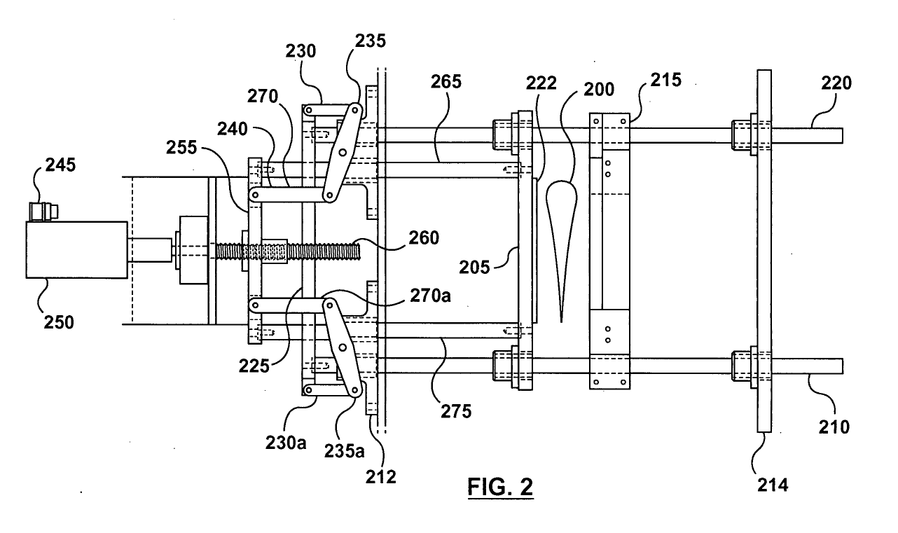

Referencing the top view in FIG. 2, from a home position indicated by a rotary encoder 245, coupled to motor 250 to track the rotational angle of the motor, the motor 250 turns ball screw 260. The ball screw 260 is received by a threaded sleeve of a driving element, namely plate 255. Thus, when the ball screw turns, this moves plate 255 either toward, or away from, stationary frame members 212, 214. The stationary frame members 212 and 214 anchor the various moving assemblies of reciprocating upper jaws 205 and 215.

Upper sealing head (jaw) 205 is bearing mounted on smooth shafts 210 and 220 which are supported by frame members 212, 214 so that the sealing head 205 slides along the shafts 210 and 220 when pushed. Sealing head 205 incorporates an elongate heating ribbon 222 that is heated by a power source (not shown).

Plate 255 is attached to the upper sealing head 205 through push rods 265 and 275. A rocker arm 235 is medially pivotably joined to frame 212. An inboard link arm 270 is pivotably mounted to the inboard end of the rocker arm and to plate 255. Movement of plate 255 toward frame 212 pushes the inboard link arm 270 toward frame 212 which, in turn, pushes the inbound end of a rocker arm 235. The rocker arm 235 is pivotably joined, at its outboard end, to an outbound link arm 230 which is, in turn, pivotably joined to a back support 225. The back support 225 is fixed to an end of shaft 220. An identical arrangement of arms 230a, 235a, 270a links plate 255 to back support 225 at smooth shaft 210. A backstop (jaw) 215 is fixed to the two smooth shafts 220 and 210 so as to move with the smooth shafts 210 and 220. Consequently, when plate 255 advances toward frame 212, pusher arms 265, 275 push sealing head 205 toward the tube 200 and toward backstop 215. Simultaneously, outbound link arms 230, 230a, pull the smooth shafts 220, 210, and therefore the backstop. In consequence, then the sealing head 205 advances toward the backstop, the backstop simultaneously advances toward sealing head 205. The backstop acts as a back stop for sealing head 205 and may, for example, be fabricated of a high density plastic material.

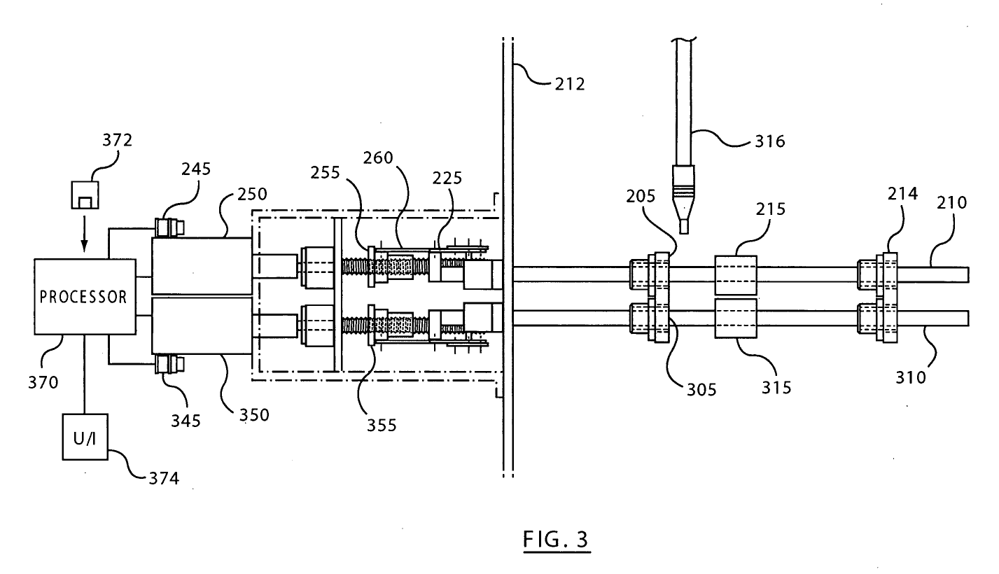

Referencing the front view of FIG. 3, the mechanism for reciprocating the sealing head and the backstop is repeated with a lower assembly comprising a lower motor 350, lower ball screw 335, lower sealing head 305 and lower backstop 315. Also shown are the rotary encoder 345 of motor 350, lower plate 355 threaded to lower ball screw 335, and one of the lower smooth shafts 310. Fluid delivery spigot 316 is shown here for delivering flowable material into the film tube (which is not shown in FIG. 3).

A processor 370 receives an output from each rotary encoder 245, 345 and outputs to a control input of each motor 250, 350. The processor is loaded with software from computer readable media 372 which may be for example, a disk, a read only memory, or a file downloaded from a remote source. Additionally, the processor may receive input from a user interface 374 which may be, for example, a keyboard.

In operation, considering the upper assembly, the advancement of plate 255 toward frame 212 moves the upper sealing head 205 and the upper backstop 215 toward one another to conduct sealing of the tube. Under control of the processor 370, with input from the rotary encoder 245, the motor rotates the ball screw 260 through an initial pre-set number of rotations, to advance the sealing head 205 and backstop 215 toward one another. The motor 250 is then decelerated, possibly to a momentary stop, in which case it is thereafter re-started. Once the motor 250 stalls out, indicating that the sealing head and backstop have been pushed against each other with the tube 200 sandwiched between them, the processor controls the motor voltage to generate a selected torque that provides a selected sealing pressure between the sealing head and backstop.

The processor may maintain the sealing pressure for a pre-determined dwell time. Thereafter, the motor 250 is reversed to draw the sealing head 205 and backstop 215 away from each other, back to the home position. The encoder 245 has kept a count throughout so that the processor can accurately reposition back to the home position.

The lower assembly works in exactly the same way. Consequently, both an upper and a lower seal may be applied to the film tube. It will be apparent that the upper and lower sealing assemblies are controlled independently by separate motors with no mechanical connection between the upper and lower sealing assemblies. Because of the independent operation of the upper and lower sealing heads 205 and 305, the sealing heads 205 and 305 may be co-ordinated in any desirable manner through software control of the processor.

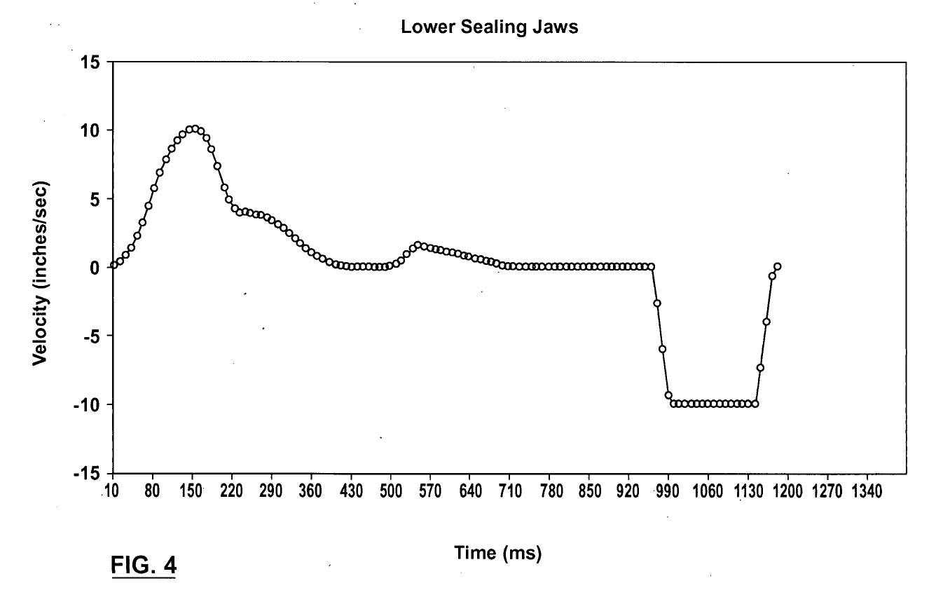

The processor 370 may control each motor according to a stored motion profile to attain a desirable velocity versus time motion profile for each pair of jaws. For example, where the flowable material is water, the profile illustrated in FIG. 4 may be used. Considering the lower sealing assembly, the movement of the lower jaws (sealing head 305 and backstop 315) toward each other can be divided into several phases. In the first phase, the processor controls the motor 350 to progressively accelerate in order to drive the lower jaws, from opposing directions, towards the film at a high rate of speed. This is indicated in FIG. 4 between roughly 0 ms to 150 ms. When the jaws impact the tube, they impart hydraulic turbulence to the fluid in the tube and vibrations to the tube. To reduce this turbulence and vibration, the motor 350 decelerates in a time window during which tube impact is expected. This window roughly spans 150 ms to 360 ms. The most likely time of impact is 220 ms, in consequence, the motor is decelerated more rapidly prior to 220 ms and more gently after 220 ms. To further reduce this turbulence and vibration, the jaws stop, roughly between 430 ms to 500 ms as shown on the graph of FIG. 4, maintaining a gap between the two layers of film for a fixed period of time. The delay and gap are programmable through the motion controller to suit the liquid being packaged, preparing for the most critical moment when the two layers of film touch and the bonding process begins.

The motor is then re-started to close the minimal gap between the jaws (between about 500 and 710 ms). As illustrated in FIG. 4, at about 710 ms the velocity of the jaws returns to zero as the motor 350 stalls when the jaws move into abutment with each other, with the tube sandwiched between them. At this point, the processor controls the motor's voltage in order to apply a selected torque to the motor. This selected torque is translated by the rotary-to-linear mechanism to result in the application of a selected force between the jaws. This force results in a selected sealing pressure on the film tube along the heated ribbon 222 of sealing head 205. Once the sealing pressure has been maintained for a desired dwell time (710 to 980 ms), the motor is reversed to return the jaws to a home position (980 to 1190 ms).

Where the flowable material is more viscous than water, the motion profile may cause the motor to decelerate in the time window of expected impact, but not stop thereafter. Instead, after decelerating during the window of expected impact, the motor may simply continue to advance the heads at a constant, or decelerating, rate, until the motor stalls.

It is important to recognise that the selected sealing pressure is achieved without the processor having direct information on the distance through which it must advance the jaws so that they abut. Instead, the processor simply keeps advancing the jaws until they do abut. Thus, the jaws have a variable (endless) stroke: they will keep advancing until they abut. This has the advantage that even with the jaws wearing down over repeated cycles of operation, they will still achieve the selected sealing pressure. For example, considering FIG. 4, it may be that, after a million cycles, the motor will not stall out until 720 ms, due to wear at the face of the jaws. In such instance, the processor will begin to control the motor voltage to achieve the selected sealing pressure at 720 ms, rather than at 710 ms. This result is in contrast to, for example, a sealing assembly having fixed stroke cylinders. In this fixed stroke arrangement, wear on the jaws will result in a reduction of the sealing pressure. This will increase the number of seals that leak. Once the quality of the seals degrades to unacceptable levels, it would be necessary to take the machine out of service for re-calibration or replacement of the jaws.

As aforenoted, the motion profile of the jaws reduces hydraulic turbulence before a seal is formed. This helps ensure the tube has a predictable shape when clamped by the jaws. In consequence, the chance of wrinkles at the seal are reduced. Furthermore, reducing the hydraulic turbulence allows the containers to have a precisely consistent volume. Coordinated motion profiles between the upper and lower sealing heads can be modified and stored to the processor to suit a range of tube diameters.

The heat of sealing may also sever the tube at the bond. Alternatively, a knife associated with the jaws, or a knife below the jaws, may be used. It will be apparent that segments of the tube which have been filled, sealed, and severed form containers, which may be in the nature of pouches.

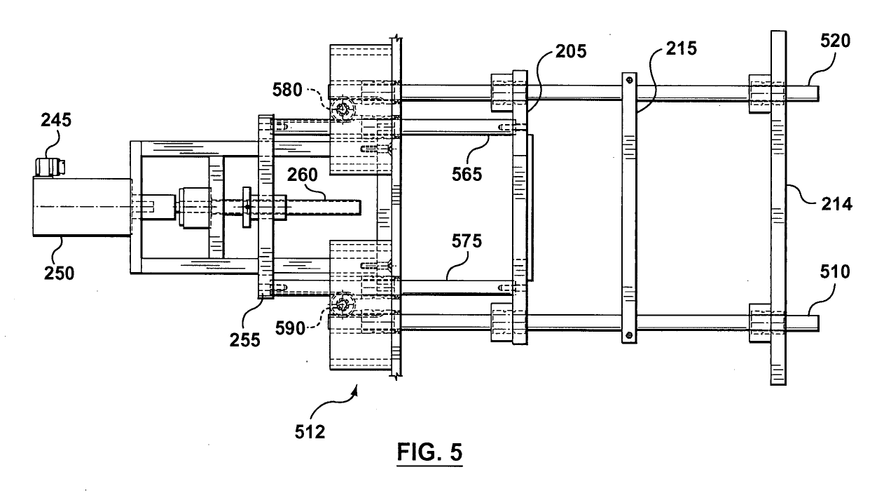

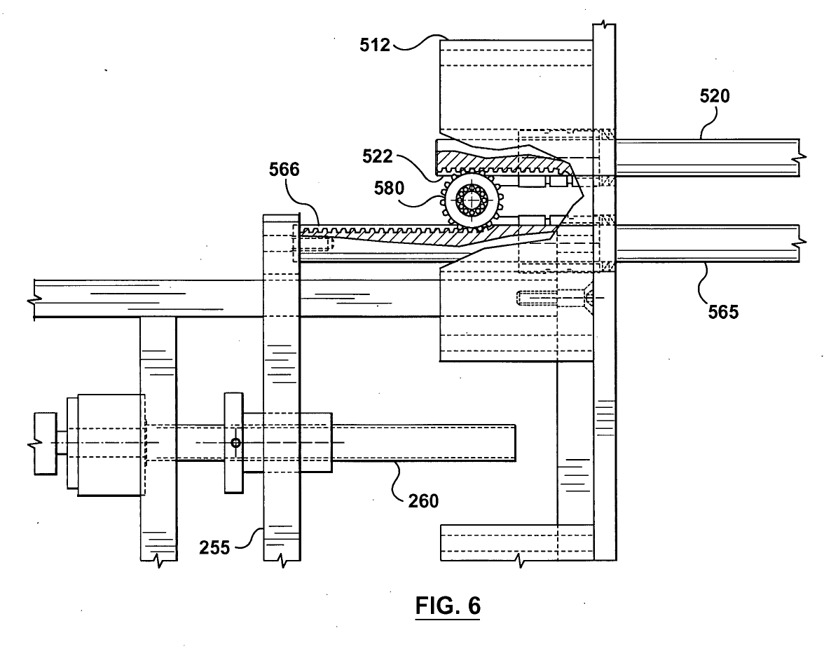

FIGS. 5 and 6 show a different implementation of this invention, using racks and pinions, instead of link arms, to drive the jaws. Turning to FIGS. 5 and 6, wherein like parts to those of FIG. 2 are given like reference numerals, plate 255 of the upper sealing assembly is joined to push rods 565, 575. A rack 566 extends from an end of each push rod, which end is joined to the plate 255. Similarly, a rack 522 extends from the end of each of shafts 510, 520, which end is proximate plate 255. Frame 512 supports two pinions 580, 590; each pinion meshes with both a rack 566 of one of the push rods 565 or 575 and a rack 522 of one of the shafts 510 or 520. In operation, when the motor rotates ball screw 260 so as to advance plate 255 toward frame 512, the push rods 565, 575 advance sealing head 205 toward the tube film (not shown) and the backstop 215. Advancement of the push rods causes the rack of each push rod to rotate the pinion that meshes with it (in a counterclockwise sense). Because each rotating pinion also meshes with a rack 522 of a shaft 510, 520, the pinion pulls each shaft 510, 520. Since backstop 215 is joined to shafts 510, 520, the result is that the backstop is pulled toward the tube and sealing head 205.

As an alternative to a rotary encoder, a position sensor may be used to sense the position of one of the linearly moving parts, such as the push rods. In such instance, the processor would learn the motor had stalled when the push rods were not moving despite the fact that the processor was applying a motivating signal to the motor. As an alternative to a rotary motor and ball screw, a linear motor may be used. In such case, the rotary encoder may be replaced with a motor position sensor or a sensor sensing the position of one of the other linearly moving parts. Obviously, the device could comprise only a single seal sealing assembly rather than the upper and lower sealing assemblies described.

Other advantages and modifications within the scope of the invention will be apparent to those skilled in the art and, therefore, the invention is defined in the claims.

1. A method for sealing a flexible tube containing a fluid, comprising:
driving opposed jaws disposed about said tube toward each other;
as said jaws deform said tube, controlling speed and rate of speed of said jaws in order to reduce turbulence of the fluid and vibration of the tube;
driving said jaws into abutment, with said tube interposed therebetween, and applying a sealing pressure for a dwell time; and
thereafter retracting said jaws.

2. The method of claim 1 wherein said controlling comprises decelerating said jaws prior to said driving said jaws into abutment.

3. The method of claim 1 wherein said controlling comprises decelerating said jaws to a stopped position whereat said jaws are spaced apart and maintaining said stopped position for a pre-determined time prior to said driving said jaws into abutment.

4. The method of claim 1 wherein said jaws are driven by a motor, said motor stalling when said jaws are driven into abutment, said applying a sealing pressure comprising torquing said motor, while stalled.

5. The method of claim 1 wherein said opposed sealing jaws comprise a first jaw with a heated ribbon and a second jaw acting as a backstop for said first jaw.

6. The method of claim 1 wherein said control comprises decelerating said jaws over a time window during which said jaws are expected to impact said tube.

7. A device for sealing a tube containing a fluid, comprising:
a pair of opposed sealing jaws disposed about said tube;
a motor for driving each one of said sealing jaws toward the other;
an indicator for indicating position of said jaws; and
a controller input by said indicator and outputting to said motor for controlling a motion profile of said sealing jaws.

8. The device of claim 7 wherein said controller is for controlling a motion profile of said sealing jaws such that said jaws are initially driven toward each other at up to a first speed, said jaws are thereafter decelerated and advanced until said motor stalls.

9. The device of claim 8 wherein said controller is for controlling said motion profile such that said jaws are decelerated to a stopped position for a pre-determined time prior to being advanced until said motor stalls.

10. The device of claim 8 wherein said controller is also for controlling a torque of said motor after said motor has stalled so as to apply a sealing pressure to said tube for a dwell time.

11. The device of claim 8 wherein said opposed sealing jaws comprise a first jaw with a heated ribbon and a second jaw acting as a backstop for said first jaw.

12. The device of claim 7 further comprising:
a driving element connected to said motor for linear movement; and
a first jaw of said sealing jaws connected to said driving element so as to move with said driving element.

13. The device of claim 12 wherein said motor is a rotary motor and further comprising a threaded shaft coupled to an output of said motor, said driving element being threaded to said shaft.

14. The device of claim 13 wherein said indicator is a rotary encoder associated with said motor.

15. The device of claim 7 further comprising:
a driving element connected to said motor for linear movement;
a first jaw of said sealing jaws connected to said driving element so as to move with said driving element;
a rack extending from said driving element;
a pinion meshing with said rack;
a rack extending from a second jaw of said sealing jaws, said rack extending from said second jaw meshing with said pinion so that said second jaw moves in an opposite direction to a direction of movement of said driving element.

16. The device of claim 15 wherein said motor is a rotary motor and further comprising a threaded shaft coupled to an output of said motor, said driving element being threaded to said shaft.

17. The device of claim 16 wherein said indicator is a rotary encoder associated with said motor.
